(19) United States
(12) Patent Application Publication
(10) Pub. No.: US 2025/0205552 A1
(43) Pub. Date: Jun. 26, 2025

(54) SYSTEMS AND METHODS FOR BALL TRAJECTORY BASED ON MACHINE LEARNING ACCORDING TO PREVIOUS TRAJECTORY ANALYSIS AND D-PLANE DETERMINATION

(71) Applicant: GOLFTEC ENTERPRISES LLC, Englewood, CO (US)

(72) Inventor: Nick Clearwater, Englewood, CO (US)

(21) Appl. No.: 18/392,117

(22) Filed: Dec. 21, 2023

(51) Int. Cl. A63B 24/00; A63B 102/32

(52) U.S. Cl. CPC A63B 24/0021; A63B 2024/0034; A63B 2102/32; A63B 2220/31; A63B 2220/35; A63B 2220/805

(57) ABSTRACT

As system for determining the trajectory of a sport object propelled via an implement includes a sensing module executing code and configured to determine launch characteristics of a sport object upon being launched. The system further includes a trajectory module executing code and configured to calculate a D-plane for an implement that struck the sport object based on the launch characteristics; and determine a trajectory for the sport object based on the launch characteristics and the D-plane.

### BACKGROUND

In various scenarios, it is desirable to calculate the trajectory of sports object, such as a golf ball. One factor that may affect the trajectory of the sports object that may not be initially detected based on the initial trajectory of the sports object is the plane of travel of the sports implement that strikes the ball. Therefore, it is desirable to calculate characteristics of the direction of travel of the sports implement.

### SUMMARY

In one embodiment, a system for determining the trajectory of a sport object propelled via an implement includes a sensing module executing code and configured to determine launch characteristics of a sport object upon being launched. The system further includes a trajectory module executing code and configured to calculate a D-plane for an implement that struck the sport object based on the launch characteristics; and determine a trajectory for the sport object based on the launch characteristics and the D-plane. In one alternative, a launch monitor, the launch monitor providing images of the sport object to the sensing module. Alternatively, the launch monitor includes an optical sensor and does not include radar. In another alternative, an optical sensing apparatus determines the launch characteristics. Alternatively, the sport object is a golf ball and the implement is a club. In another alternative, the launch characteristics include a sport object velocity, a sport object launch angle, and a sport object spin. Alternatively, the D-plane is a calculated striking angle of the club. In another alternative, the D-plane of the club is referenced a database of D-plane measurements and associated trajectories to influence the trajectory for the sport object. In one alternative, the D-Plane is used to calculate the spin of the sports object. In another alternative, the D-Plane is used to calculate the sport object spin.

In one embodiment, a method for determining the trajectory of a sport object propelled via an implement includes determining launch characteristics of a sport object upon being launched. The method further includes calculating a D-plane for an implement that struck the sport object based on the launch characteristics. The method further includes determining a trajectory for the sport object based on the launch characteristics and the D-plane. Alternatively, an optical sensing apparatus determines the launch characteristics. In one alternative, the sport object is a golf ball and the implement is a club. In another alternative, the launch characteristics include a sport object velocity, a sport object launch angle, and a sport object spin. Alternatively, the D-plane is a calculated striking angle of the club. In another alternative, the D-plane of the club is referenced a database of D-plane measurements and associated trajectories to influence the trajectory for the sport object. In one alternative, the D-Plane is used to calculate the spin of the sports object. In another alternative, the D-Plane is used to calculate the sport object spin.

In another embodiment, a system for determining the trajectory of a sport object includes a launch monitor, the launch monitor providing a least one sensor for detecting the trajectory of a sport object. The launch monitor further includes an object trajectory predictor, the object trajectory predictor executing code. The code causes the system to determine a plurality of predicted sport object trajectories based on sensor data from the at least one sensor and causes the system to collect data concerning the plurality of predicted sport object trajectories. The system receives data on a plurality of actual sport object trajectories, corresponding to the plurality of predicted sport object trajectories and analyzes a difference between the plurality of actual sport object trajectories and plurality of predicted sport object trajectories. The system adjusts a physic model according to the difference. In one alternative, the object trajectory predictor calculates a D-plane in the analyze step and wherein the D-Plane is used to calculate the sport object spin.

### BRIEF DESCRIPTION OF THE FIGURES

FIG. 1 shows one embodiment of a system for calculating trajectories;

FIG. 2 shows one embodiment of a launch monitor;

FIG. 3 shows a flow chart for one embodiment of a method for determining the trajectory of a sports object;

FIG. 4 shows one embodiment a system diagram for a system for calculating a DP Trajectory;

FIG. 5 shows one embodiment of a class diagram for the calculation of a DP Trajectory;

FIG. 6 provides one embodiment of a swimlane diagram for a DP Trajectory System; and

FIG. 7 shows one embodiment of a diagram for D-plane calculation;

FIG. 8 shows one embodiment of a diagram for D-plane calculation;

FIG. 9 shows one embodiment of a spin diagram for D-Plane calculation.

### DETAILED DESCRIPTION

Certain terminology is used herein for convenience only and is not to be taken as a limitation on the embodiments of the Systems and Methods for Ball Trajectory Based on Machine Learning according to previous trajectory analysis and D-Plane determination (DP Trajectory). In many embodiments of a DP Trajectory system, the system includes an optical trajectory analysis system. This system captures characteristics of a launched ball. In many configurations, the ball is a golf ball. Typically, then the system could calculate a trajectory of the ball. However, some characteristics of the trajectory may not be captured by merely comparing trajectories of the launched ball to previous launched balls and using physics calculations. Therefore, it is many times desirable to capture characteristics of the club or implement striking the ball to better predict the trajectory of the ball. However, in some circumstances, the club characteristics may not be available. This is because the club characteristics are many times best captured by a radar system and the particular launch monitor used may only provide optical analysis. Therefore, it is desirable to calculate club characteristics from the measured ball characteristics and use this to better determine the trajectory of the ball, via both physics models and statistical models. In many scenarios, this involves calculating a D-plane of the club. The D-plane is trajectory of the club when the ball is struck, including the angle compared to the launch angle or compared to some other determined reference. Ultimately, this amounts to the spin (tilt axis of the ball) of the ball in combination with the initial direction of the ball. As may be seen, the angle that the ball launches may not translate to the direction of spin of the ball. In other words, the launch angle may differ from the spin direction of the ball. However, the spin axis of the ball is perpendicular to the D-Plane. Therefore, since the D-Plane may be calculated in many scenarios, the axis of spin of the ball may also be determined. This can occur with or without optical systems that may optically determine the direction of spin of the ball. Therefore, the D-Plane may serve as an independent calculation of ball spin or a double check or back up determination of ball spin. Ball spin has a significant effect on the trajectory of travel of the ball.

The definition of what the D-Plane entails, is not absolute, but essentially, it is the predicted path of the club when striking the ball and immediately thereafter. The D-Plane in many scenarios may be used to determine the spin of the ball which in turn informs the trajectory of the ball. However, the D-Plane may be applied to other calculations as well. One such scenario is analysis of the swing of the user. The plane of a user's swing during ball contact and immediately thereafter are very important in determining the trajectory of the ball and the correction of the direction of the D-Plane may be important to the correction of the user's swing. The D-Plane is the spin (tilt axis of the ball) of the ball in combination with the initial direction of the ball.

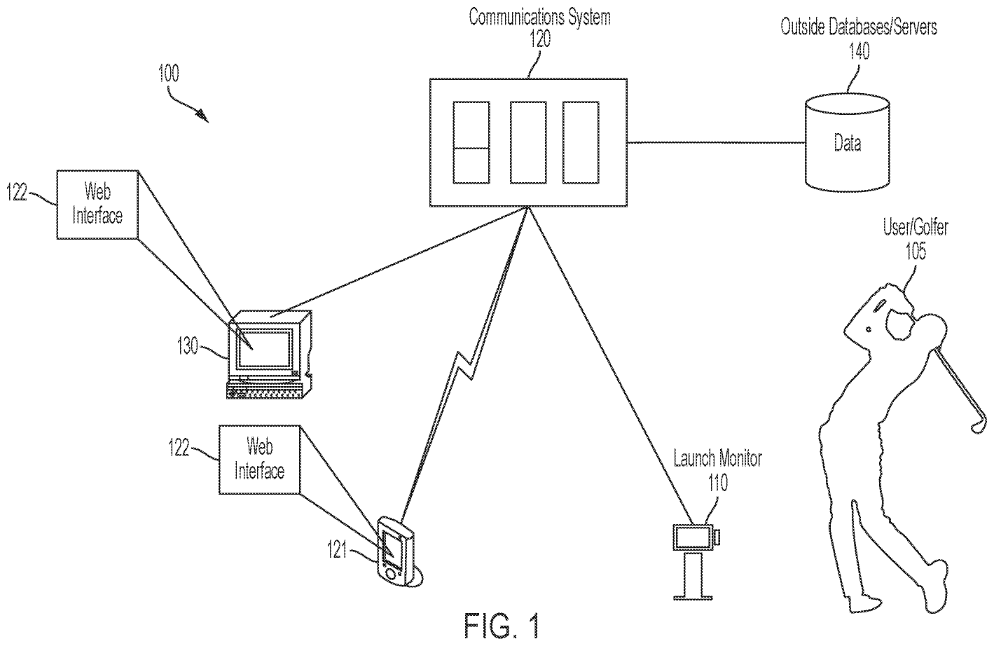

FIG. 1 shows one embodiment of a system 100 for calculating trajectories. System 100 includes one or more launch monitors 110. Launch monitors 110 track the swing trajectory and/or the ball trajectory created by golfer 105 when a ball is struck. Launch monitor 110 may communicate via wired or wireless communication with communications system 120, typically a wired, wifi, or Bluetooth system, however various other communications protocols may be used. Communications system 120 may communicate with computer 130, which may have a web interface 122 or other user interface including customized GUIs and other interfaces used in sports computing systems. Alternatively, communications system 120 may communicate with mobile device 121, which may be a smart phone, tablet, or other mobile device. Communications system 120 in many configurations communicates with remote resources, such as servers or databases 140, which provide for more powerful trajectory calculation systems, simulation systems, or databases of comparable players (including videos, images, or swing movies) or other information. In some alternatives, launch monitor 110 may be directly wired to computer 130 or communicate directly with mobile device 121. Numerous possibilities and alternative configurations exist, within typical device setup.

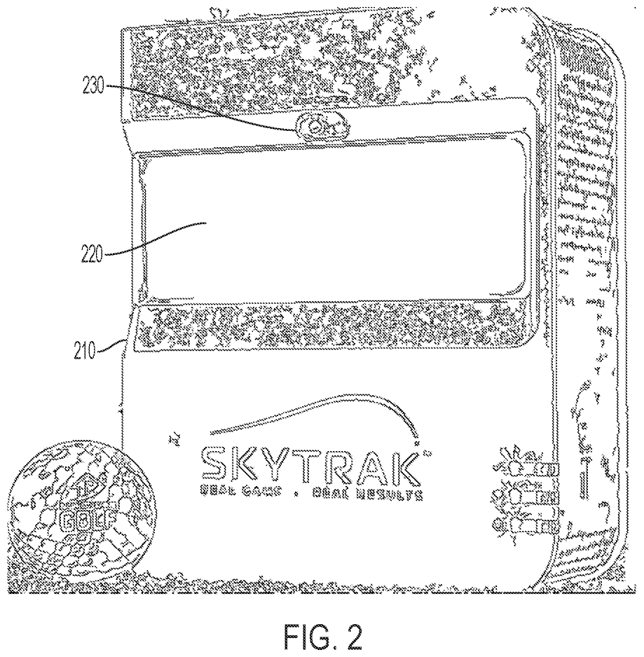

FIG. 2 shows one embodiment of a launch monitor 210 (corresponds to launch monitor 110 in FIG. 1). Launch monitor 210 includes a optical sensing system 220, that may include one or more cameras for tracking the trajectory of a ball and/or club. Launch monitor 210 also includes radar sensing system 230 for tracking the trajectory of a ball and/or club. Launch monitor 210 may in some alternatives, include only one of optical sensing system 220 and radar sensing system 230. Launch monitor 210 includes a processor and communication system for processing raw data recording into a form that is easily transmitted and processed by another computing device. In some scenarios, the launch monitor may not have sensitive enough instruments to determine the spin of a ball based on the imaging or the system may fail to reliably determine a ball spin.

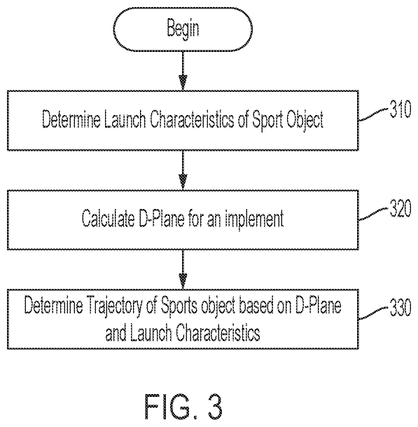

FIG. 3 shows a flow chart for one embodiment of a method for determining the trajectory of a sports object. In step 310, the launch characteristics of the sports object is determined. This is typically performed via a launch monitor. In many configurations, this is done optically, with one or more cameras. In many configurations, the sports object is a ball. In many embodiments, the launch monitor does not include radar, only optical sensors. In many configurations, the ball is a golf ball. In step 320, a D-Plane for a sports implement is calculated. Typically, the implement is a golf club. In many configurations, the D-Plane is the direction of travel of the sports implement, which may be different from the initial launch characteristics of the ball/sports object. In step 330 the launch characteristics and the D-Plane are used to compute the trajectory of the ball.

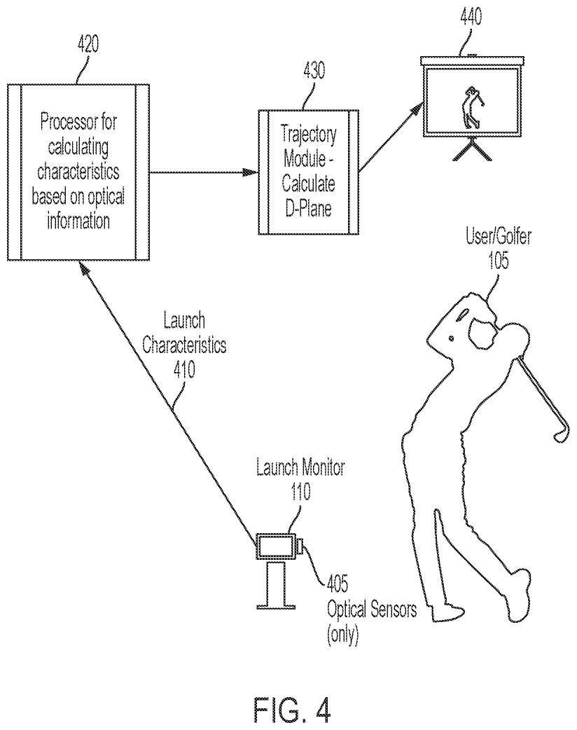

FIG. 4 shows one embodiment a system diagram for a system for calculating a DP Trajectory. Here, a user/golfer 105 is monitored by launch monitor 110. Launch monitor 110 in many scenarios includes optically sensors only, therefore making the tracking of a club (without radar) difficult. The launch monitor sends launch characteristics 410 of the ball to the processors 420. Such characteristics may be merely timed photos/images or video. Processor 420 calculates various characteristics of the launch, such as spin, speed, and direction. Calculation of the spin of the ball may be limited to assumptions based on the club used. Next the trajectory module 430 calculates the D-Plane. Then the trajectory of the ball is calculated using the D-Plane. At screen 440 the trajectory of the ball is simulated.

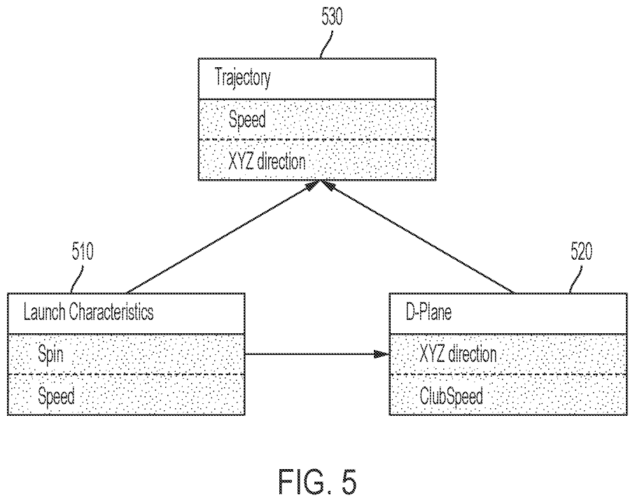

FIG. 5 shows one embodiment of a class diagram for the calculation of a DP Trajectory. Launch Characteristics class 510 includes information about the spin and speed of the ball. These characteristics are passed to the D-Plane class, which incudes the XYZ direction of the club (the D-Plane) and the club speed. Both Launch Characteristics 510 and D-Plane 520 are used to determine the Trajectory 530, which includes the speed and XYZ direction of the ball. The D-Plane will assist in many scenarios in the calculation of spin of the ball and the adjustment of the trajectory accordingly.

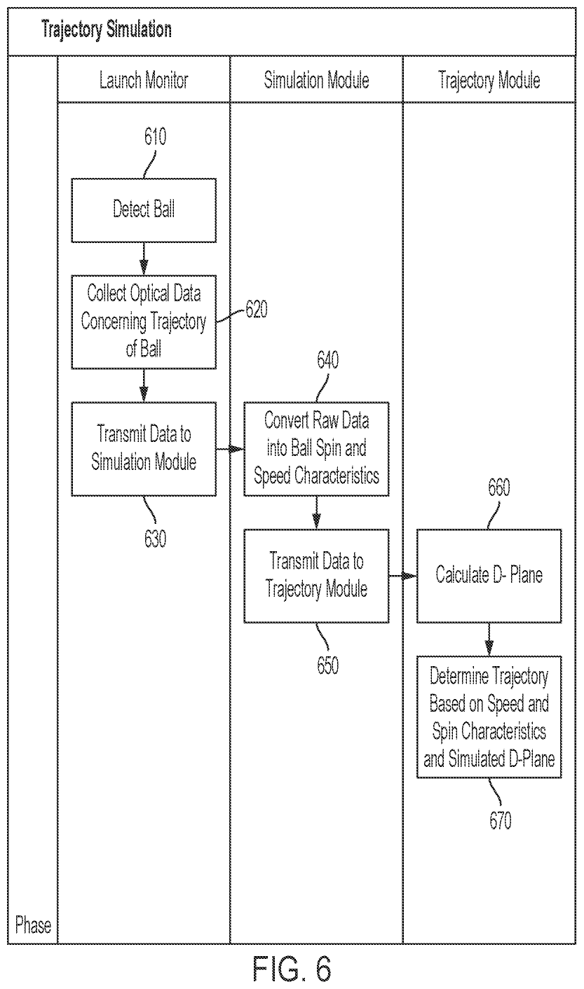

FIG. 6 provides one embodiment of a swimlane diagram for a DP Trajectory System. Here, the launch monitor detects the ball in a first step 610. Then the launch monitor collects optical data concerning the trajectory of the ball in step 620. In step 630 this is transmitted to the simulation module. In step 640, the simulation module coverts raw data into spin and speed characteristics. In step 650, data is transmitted to the trajectory module. The Trajectory module then calculates the D-Plane in step 660. Then using the D-plane and the other ball characteristics, the trajectory is calculated in step 670.

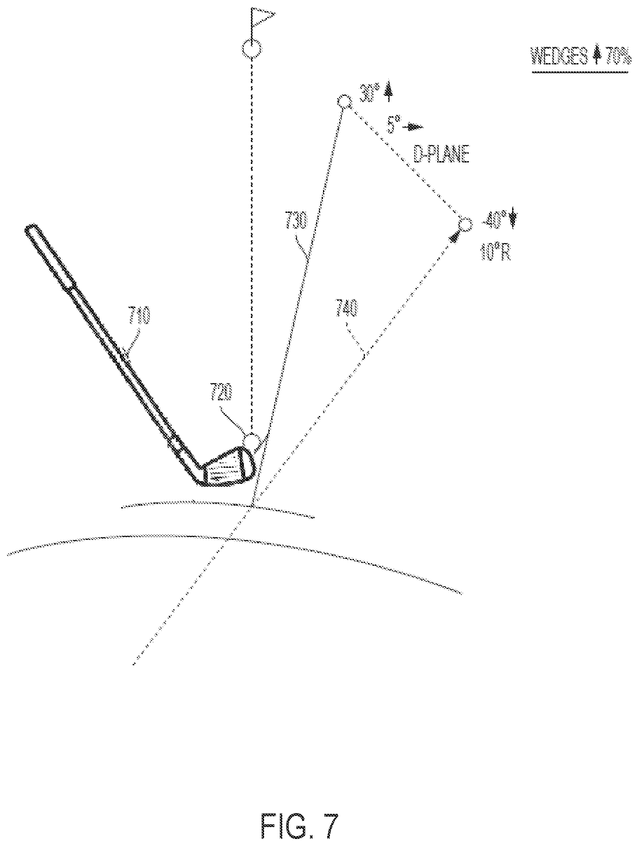

FIG. 7 shows one embodiment of a diagram for D-plane calculation. As shown, club 710 strikes ball 720. This gives the ball an initial vector shown by line 730. At the same time, the path of travel of the club is represented by D-Plane 740. Since this path of travel is different from the initial vector of line 730, the actual travel of the ball may vary according to the D-Plane. Generally, in many scenarios, the D-Plane is used to calculate the spin of the ball. There may be other subtle factors that may be interpreted via the D-Plane calculation that may be determined by data analysis or interpolation of the data.

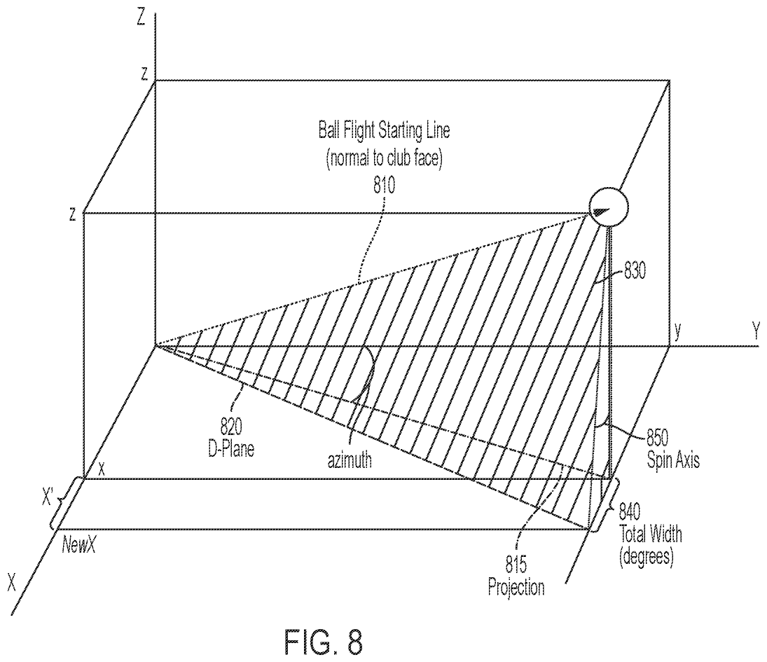

FIG. 8 shows a conceptual model of the D-Plane. The model shown is projected in an xyz coordinate system framework. As can be seen in this figure, line 810 represents the initial ball flight starting line, normal to the club face. Projection 815 is also drawn on the X-Y plane. For different clubs, the angle between the D-Plane x-y intercept line 820 and the projection 815 will vary. Finally, the D-Plane 830 is shown, representing the plane of movement of the club during impact with the ball and proximate to impact. From this, the spin axis 850 and the total width 840 between projection 815 and D-Plane intercept line 820 may be calculated.

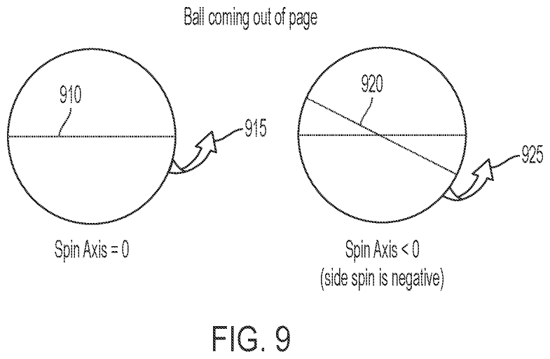

FIG. 9 shows the relationship between the spin axis and the D-Plane. The spin on the left ball is ordinarily assumed to rotate around axis 910, which is an axis perpendicular to the ground and the ball is usually assumed to have back spin 915. This results from a D-Plane path approximately in line with the direction of travel of the ball. It however is often the case that the D-Plane path is not exactly in line with the direction of travel of the ball. Instead, as shown in the image on the right, the axis of spin 920 is offset and the spin 925 is not an exact back spin.

In various scenarios, the D-Plane may or may not be reflective of the axis of rotation of the ball. Generally, the D-Plane relates to the axis of rotation if the launch angle falls into certain parameters. If the launch angle falls out of certain parameters, the strike is generally considered anomalous. This is large dependent on the club used. The disclosed ranges are merely exemplary, and various other ranges may be utilized. Anomalous launches generally fall outside the below indicated ranges:
Drives->Launch Angle<5 degrees or >20 degrees
Irons->Launch Angle<5 degrees and Azimuth<−20 degrees
Wedge->All shots use D-Plane calculation

As shown, for wedges the D-Plane spin calculation generally applies. Due to the club head orientation, for the various other clubs, the calculation applies when the launch of the ball is within expected launches for the club. For instance, for drivers, the launch must be off the ground, launch angle greater that 5 degrees, but not a popup (launch angle less than 20 degrees), since standard drivers hit the equivalent of a line drive in baseball, relatively low launch angle but not on the ground. For irons, the launch angle similarly cannot be on the ground, and the azimuth must be within certain ranges, indicating that a significant mishit did not occur. Various additional parameters may be developed for limitations as to when D-Plane can apply, either on a player, club, or set of club basis (or other basis). In some alternatives, the D-Plane calculation may be used regardless of the club and the circumstances of the shot. The above rule of thumb is merely one example of how to incorporate the D-Plane. In addition, the D-Plane calculation may be enhanced by machine learning.

In some embodiments, the D-Plane calculated using other known conditions of the swing. Using the launch angle and the tilt of the ball the D-Plane is back calculated. This is based on using the spin of the ball-initial launch angle to using derive club face and swing direction.

Additionally, the D-plane calculation may be used for other sports. Generally, it will be most appropriate for sports utilizing an implement such as a club or bat but can be implemented in sports without. Generally, the calculation rests on providing a strike point on an implement, where an object, generally a ball, but not limited to a ball, will be struck. The strike point is generally attached to a lever arm, such that the direction of travel of the strike point will not be completely inline with the direction of travel of the object. Therefore, the lever arm will have a plane of travel during and immediately after the striking of the object: a D-Plane. This D-Plane will generally be related to the spin put on the object. For instance, in tennis, players frequently put top spin or other spin on the ball (slice). Although, the direction of travel of the ball is generally perpendicular to the strike point, the direction of travel of the ratchet, after and during the strike, will generally put spin on the ball. This is applicable to sports like soccer as well, where the leg is the lever arm and the foot is effectively the clubhead. Other sports this applies to include, ice hockey, street hockey, field hockey, tennis, soccer, volleyball (with the hand being the clubhead and the arm the lever arm), cricket, baseball (the bat is the lever arm and the strike point on the bat, which varies, becomes the clubhead), and other sports having a strike point and a path of travel of the strike point differing from the direction of travel of the object.

In the context of baseball, based on the spin and initial trajectory of the ball a D-Plane may be calculated. From these parameters we may calculate th bat face position and the initial bat swing direction.

For golf, the D-Plane may be used

X′=z*TAN(−SpinAxis)

NewX=X′+x

DPlane=A TAN(NewX/y)

The spin x-axis is always perpendicular to the D-Plane. For a driver, 90% of the starting angle is due to club face. Generally, the calculation may proceed according to the following:
1. Using the x-y projections of the club face normal and the D-Plane,

9/10 of TotalWidth=D-Plane−azimuth, so we can write

TotalWidth=10/9*(D-Plane−azimuth)
2. Let Face To Target=azimuth−0.1 Total Width (i.e., 10% of the width computed)
3. Set predicted ClubPath=D-Plane
4. Set predicted Face to Path=FaceToTarget−ClubPath
For an iron, 80% of the starting angle is due to club face, so we get 8/10 of TotalWidth=D-Plane−azimuth, so we can write

TotalWidth=10/8*(D-Plane−azimuth)
FaceToTarget=azimuth−0.2*Total Width (i.e., 20% of the width computed)
For a wedge, 70% of the starting angle is due to club face, so we get 7/10 of TotalWidth=D-Plane−azimuth, so we can write

TotalWidth=10/7*(D-Plane−azimuth)
FaceToTarget=azimuth−0.3·Total Width (i.e., 30% of the width computed)

The D-Plane is typically used in the calculation of the spin of the ball. The D-Plane optional may be used in the context of Hidden Markov Models and/or Gaussian Mixture Models and other data clustering methods. In such a method, known data points for ball trajectory characteristics and D-Plane characteristics are clustered according to known flight data of the ball or simulated flight data of the ball simulated with a system of known greater accuracy. Then when a new data point of ball trajectory characteristics and D-Plane is provided, the new point is matched to existing clusters and interpolation between clusters is calculated to provide for variance. A least squares distance calculation may be utilized.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

In various instances, parts of the method may be implemented in modules, subroutines, or other computing structures. In many embodiments, the method and software embodying the method may be recorded on a fixed tangible medium.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

1. A system for determining the trajectory of a sport object propelled via an implement, the system comprising:
a sensing module executing code and configured to:
determine launch characteristics of a sport object upon being launched;
a trajectory module executing code and configured to:
calculate a D-plane for an implement that struck the sport object based on the launch characteristics;
determine a trajectory for the sport object based on the launch characteristics and the D-plane.

2. The system of claim 1, further comprising:
a launch monitor, the launch monitor providing images of the sport object to the sensing module.

3. The system of claim 2, wherein the launch monitor includes an optical sensor and does not include radar.

4. The system of claim 3, wherein an optical sensing apparatus determines the launch characteristics.

5. The system of claim 4, wherein the sport object is a golf ball and the implement is a club.

6. The system of claim 5, wherein the launch characteristics include a sport object velocity, a sport object launch angle, and a sport object spin.

7. The system of claim 6, wherein the D-plane is a calculated striking angle of the club.

8. The system of claim 7, wherein the D-plane of the club is referenced a database of D-plane measurements and associated trajectories to influence the trajectory for the sport object.

9. The system of claim 1, wherein the D-Plane is used to calculate the spin of the sports object.

10. The system of claim 6, wherein the D-Plane is used to calculate the sport object spin.

11. A method for determining the trajectory of a sport object propelled via an implement, the method comprising:
determining launch characteristics of a sport object upon being launched;
calculating a D-plane for an implement that struck the sport object based on the launch characteristics;
determining a trajectory for the sport object based on the launch characteristics and the D-plane.

12. The method of claim 9, wherein an optical sensing apparatus determines the launch characteristics.

13. The method of claim 20, wherein the sport object is a golf ball and the implement is a club.

14. The method of claim 11, wherein the launch characteristics include a sport object velocity, a sport object launch angle, and a sport object spin.

15. The method of claim 12, wherein the D-plane is a calculated striking angle of the club.

16. The method of claim 13, wherein the D-plane of the club is referenced a database of D-plane measurements and associated trajectories to influence the trajectory for the sport object.

17. The method of claim 11, wherein the D-Plane is used to calculate the spin of the sports object.

18. The method of claim 14, wherein the D-Plane is used to calculate the sport object spin.

19. A system for determining the trajectory of a sport object, the system comprising:
a launch monitor, the launch monitor providing a least one sensor for detecting the trajectory of a sport object;
an object trajectory predictor, the object trajectory predictor executing code;
determines a plurality of predicted sport object trajectories based on sensor data from the at least one sensor;
collects data concerning the plurality of predicted sport object trajectories;
receives data on a plurality of actual sport object trajectories, corresponding to the plurality of predicted sport object trajectories;
analyze a difference between the plurality of actual sport object trajectories and plurality of predicted sport object trajectories;
adjusting a physic model according to the difference.

20. The system of claim 19, wherein the object trajectory predictor calculates a D-plane in the analyze step and wherein the D-Plane is used to calculate the sport object spin.
